(19) United States
(12) Patent Application Publication
(10) Pub. No.: US 2005/0242126 A1
(43) Pub. Date: Nov. 3, 2005

(54) Dispenser for highly viscous liquids and pastes

(76) Inventor: Jolly Fields Izoe, Oklahoma City, OK (US)

Correspondence Address: Jolly Fields Izoe, 2600 N. W. 63rd. St., # 99, Oklahoma City, OK, 73116-4928, US

(21) Appl. No.: 10/826,795

(22) Filed: Apr. 16, 2004

(51) Int. Cl. B67D 5/42; G01F 11/00

(52) U.S. Cl. 222/386

(57) ABSTRACT

A throw-away dispenser—with leverage to maintain precise control of highly viscous liquids and pastes; to keep air away from product until dispensed; to expel virtually all product. Hollow cylinder is provided with threaded hub to receive threaded actuator rod. On initial filling—nozzle section locks into cylinder to move product to nozzle tip—to expel virtually all air from dispenser. Vent holes in top of cylinder allow sealant to be placed above ram “O” ring. Lock ring prevents nozzle section from being rotated out of cylinder. Knob sleeve rotates actuator disk and spindle within ram wells—to move ram down to expel product—without rotating ram. Nozzle saucer allows product to be pumped into saucer reservoir. Close-off valve automatically adjusts for viscosity of product—and pulls excess product back inside nozzle tip. Nozzle cap(s) clean nozzle interior and push close-off valve back to original position.

### BACKGROUND OF THE INVENTION

The present invention relates to a throw-away dispenser with leverage to precisely control amount of highly viscous liquids and pastes dispensed, with provision to remove air from container on initial filling by manufacturer, to preserve the integrity of the product by keeping air away from product until dispensed, to maintain a clean nozzle tip, to stop flow of product after actuator knob is released, to dispense virtually all product from dispenser.

There are a large number of dispensers available which are useful to dispense such food products as mayonnaise, catsup, mustard, and the like, as well as toothpaste and other products. In conventional containers for dispensing these viscous liquids, the product within the dispenser becomes exposed to air once the seal is broken and some of the contents are dispensed. Moisture in the air above the product condenses when the dispenser is placed in the refrigerator for storage between uses thereby depositing water on the product. Dispensers placed on counters in fast food and other restaurants represent an unsanitary condition due to ambient air coming into contact with the liquid within the dispenser. There are no inexpensive throw-away dispensers available which have leverage to dispense highly viscous products as caulking and peanut butter.

A number of patents have been issued which disclose dispensers of viscous liquids.

U.S. Pat. No. 3,999,691 discloses a cake filler dispensing apparatus for semi-fluid material having a housing with a vertical bore and a second bore with a piston connecting with this vertical bore. APPARATUS IS COMPLICATED IN STRUCTURE.

U.S. Pat. No. 4,050,612 shows a dispensing container for flowable materials such as creams—includes a pair of opened ended containers nested telespocially with a piston in the upper container. DISPENSER IS INCONVENIENT TO USE AND DOES NOT ALLOW PRECISE DISPENSING OF PRODUCT.

U.S. Pat. No. 4,154,371 is a dispensing container with a piston forming the bottom of the container with a compressible container, lying in front of the piston and having a mouthpiece. Expelling of the product from the mouthpiece would have a vacuum effect to pull the piston upward. LEVERAGE TO PULL PRODUCT TO ORFICE IS LIMITED.

U.S. Pat. No. 4,323,177 shows an injection piston for use in cylindrical dispensing containers or packages of the type containing viscous or plastic masses such as sealing compounds or adhesives. Ejection pressure is used to increase the effective diameter of the piston top to seal air from product during ejection. PISTON PRESSURE BY COMPRESSED AIR IS COMPLICATED AND INCONVENIENT.

U.S. Pat. No. 4,479,592 describes a dispenser for providing measured amounts of a paste in which actuator is depressed down. Piston casing cannot move down because of the gripping action of a reed spring clip. When actuator is released, spring clip pushes piston upward to dispense measured amount. LEVERAGE IS LIMITED TO STRENGTH OF SPRING CLIP. DOES NOT PROVIDE COMPLETE SEALING OF PRODUCT.

U.S. Pat. No. 4,767,032 has a dispenser with a hollow dispensing tube reciprocating within the container which incrementally moves a piston downward for forcing paste upward. Ratchet has outward projecting spring with tangs to grip the smooth inner cylinder. LEVERAGE IS MINIMAL. DOES NOT MAINTAIN A CLEAN EJECTION TIP.

U.S. Pat. No. 4,886,186 discloses a dispenser for the delivery of dosed amounts of a pasty substance having a push button mounted on the receptacle for movement upwardly and downwardly adjacent an end thereof. A toothed rod extends through the receptacle and is connected at its inner end to a follower plunger. Upward movement of plunger is effected either by vacuum or a spring. LEVERAGE IS WEAK. SEALING IS INEFFECTIVE.

U.S. Pat. No. 5,170,913 shows a container with a discharge outlet and a pliant tubular wall. Squeezing of pliant tubular wall expels product. A piston follower has seals that slide on inner wall to prevent entry of air into product. SQUEEZING OF PLIANT TUBE WOULD NOT EXERT ENOUGH FORCE TO ASSURE PISTON FOLLOWER WOULD SLIDE INSIDE PLIANT TUBE.

U.S. Pat. No. 5,547,107 shows a dispenser for flowable materials which includes an outer barrel telescoped over a sealable plunger. Moving outer barrel down forces product out spout in barrel. NO LEVERAGE ADVANTAGE. PROBLEM IN MAINTAINING CONCENTRICITY.

U.S. Pat. No. 5,720,416 has a dispenser for viscous liquids in which two vane blades rotate to close out on two stationary walls in circular chamber with the ability to dispense two products simultaneously. THERE IS NO LEVERAGE ADVANTAGE AS KNOB ROTATING VANE BLADES MOVES SAME AMOUNT AS VANE BLADES.

U.S. Pat. No. 6,655,557 B2 describes a dispensing device for dispensing a viscous product as a cream or gel. Top of device has outer threads that are manually rotated through inner threads of container to force out product. DEVICE WOULD BE HARD TO ROTATE AND DIFFICULT TO MANUFACTURE.

None of the above patents teaches the present invention.

### SUMMARY OF THE INVENTION

This invention provides a throw-away dispenser with leverage to precisely control amount of product dispensed for highly viscous liquids and pastes as caulking, peanut butter and viscous products as mayonnaise, glues, paints, etc.

Nozzle section has ability to expel air from dispenser on initial packaging by manufacturer, to keep air away from product until dispensed and to expel virtually all product within container, and is inexpensive to maufacture.

A dispenser for highly viscous liquids and pastes in which a hollow cylinder is provided with a threaded hub at one end. Vent holes on top of cylinder allows sealant as paraffin to be placed above “O” ring seal for longer shelf life.

Inside top of knob sleeve is attached to top of threaded actuator rod. Rotation of knob has knob sleeve rotating around and down cylinder outer circumference wall.

Actuator rod threads downward through cylinder threaded hub—rotating actuator rod spindle and disk inside ram bottom wells. This action moves ram toward nozzle opening—without rotating ram.

Actuator spindle bottom touchs ram bottom well—slightly before disk bottom wall touchs ram well. This centers downward force at center of ram. Spindle vertical wall—rotating in ram bottom well; and disk horizontal wall—rotating in upper ram well—prevent ram from tilting—to assure smooth downward movement to precisely control amount dispensed.

After cylinder is filled with product, nozzle section locks into and seals open end of cylinder from inside, outside and bottom. Nozzle bottom simultaneously moves up in cylinder bottom to force product to nozzle tip and remove virtually all air from container.

Nozzle tip is provided with a valve that concaves upward. Valve has four slits that create four flaps. Valve wall at center of slits is thinner and progressively becomes thicker toward outer circumference.

Flaps open under pressure when knob is rotated and close when knob is released. Flaps open small amount for less viscous products and more for highly viscous products to automatically compensate for viscosity of product.

Both P6 nozzle cap and P12 small dual nozzle cap are designed to clean nozzle inner tip and push valve back to original position to prevent sticking.

Product can be dispensed over a period of time without the need for a nozzle cap to prevent leakage.

Nozzle section placed into bracket has nozzle tip pointing down. Knob placed in bracket has nozzle tip pointing up. Nozzle saucer with hex center hole can be placed over hex nozzle tip and rotated to pump products—as artists' paints lotions, bean—cheese dips, etc.—into saucer.

Knob sleeve can be placed in horizontal position. Products that have oil rising to top—such as natural peanut butter would have oil automatically integrated into mixture with nozzle section-cylinder rotating—with knob locked in bracket

It is thus a principal object of this invention to provide an inexpensive, convenient, efficient and effective apparatus for the dispensing of highly viscous liquids as caulking and peanut butter as well as a large number of food, medical and industrial products, to keep air away from product, to control amount dispensed, to close off air after dispensing action, to dispense all product and maintain a clean nozzle tip.

Ram bottom is same configuration as nozzle section. At extreme bottom product close-out, ram completely fills up nozzle section—to expel virtually all of the product from container.

Other objects and advantages of this invention will hereinafter become obvious from the following detailed description of preferred embodiments of this invention.

### BRIEF DESCRIPTION OF THE DRAWINGS

The following figures illustrate preferred embodiments of the dispenser of this invention:

FIG. 1 is perspective view of the the preferred embodiment of assembled parts of invention with dispenser in empty position—knob sleeve locked in bracket—with P12 small dual nozzle cap on nozzle tip with nozzle cleaner inside tip—especially convenient for commercial and industrial use in dispensing caulking, glue, paint, etc.

FIG. 2 is perspective view of the preferred embodiment of assembled parts of invention with dispenser in fill position—nozzle section locked in bracket—P6 nozzle cap locked into nozzle section—appropriate for dispensing viscous and highly viscous products as caulking, peanut butter—as well as cosmetic pastes, lotions, mustard, catsup, medical products and thousands of other products.

FIG. 3 is perspective view of preferred embodiment of assembled parts of invention with dispenser in empty position—knob sleeve locked in bracket—with P11 nozzle saucer attached to nozzle tip—appropriate for pumping viscous and highly viscous products as artists' paints, lotions, bean—cheese dips into saucer.

FIG. 4, Part 2 is perspective view from top of knob sleeve.

FIG. 5, Part 9 is perspective view from top of lock ring.

FIG. 6, Part 1 is perspective view from top of cylinder.

FIG. 7, Part 3 is perspective view from side of threaded actuator rod.

FIG. 8, Part 4 is line drawing from side of ram.

FIG. 9, Part 5 is perspective view from top of nozzle section.

FIG. 10, Part 5 is perspective view of nozzle section inverted.

FIG. 11, Part 11 is perspective view from top of nozzle saucer.

FIG. 12, Part 11 is perspective view of nozzle saucer—inverted.

FIG. 13, Part 10 is perspective view from top of bracket.

FIG. 14, Part 6 is perspective view from inside nozzle cap.

FIG. 15, Part 7 is line drawing from side of close-off valve.

FIG. 16, Part 7 is perspective view from top of close-off valve.

FIG. 17, Part 12 is perspective view of small dual nozzle cap—with nozzle hex up.

FIG. 18, Part 12 is perspective view of small dual nozzle cap—with nozzle cleaner up.

FIG. 19, Part 8 is perspective view of rubber “O” ring seal.

### DESCRIPTION OF THE PREFERRED EMBODIMENTS

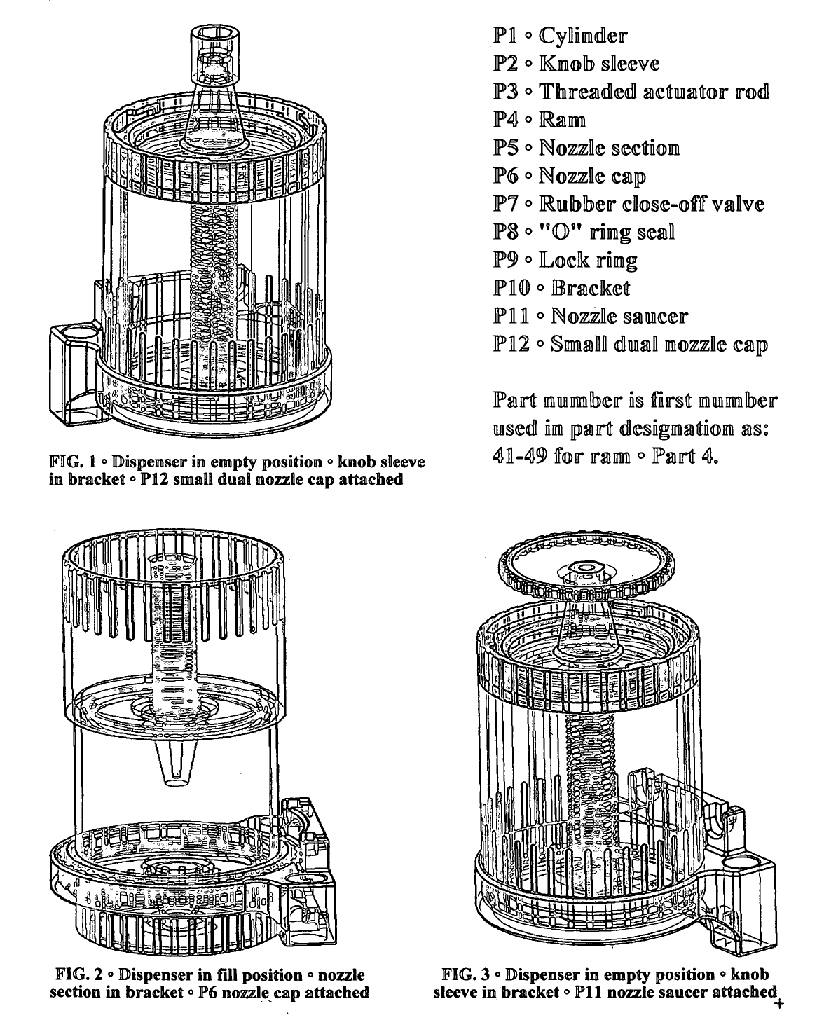

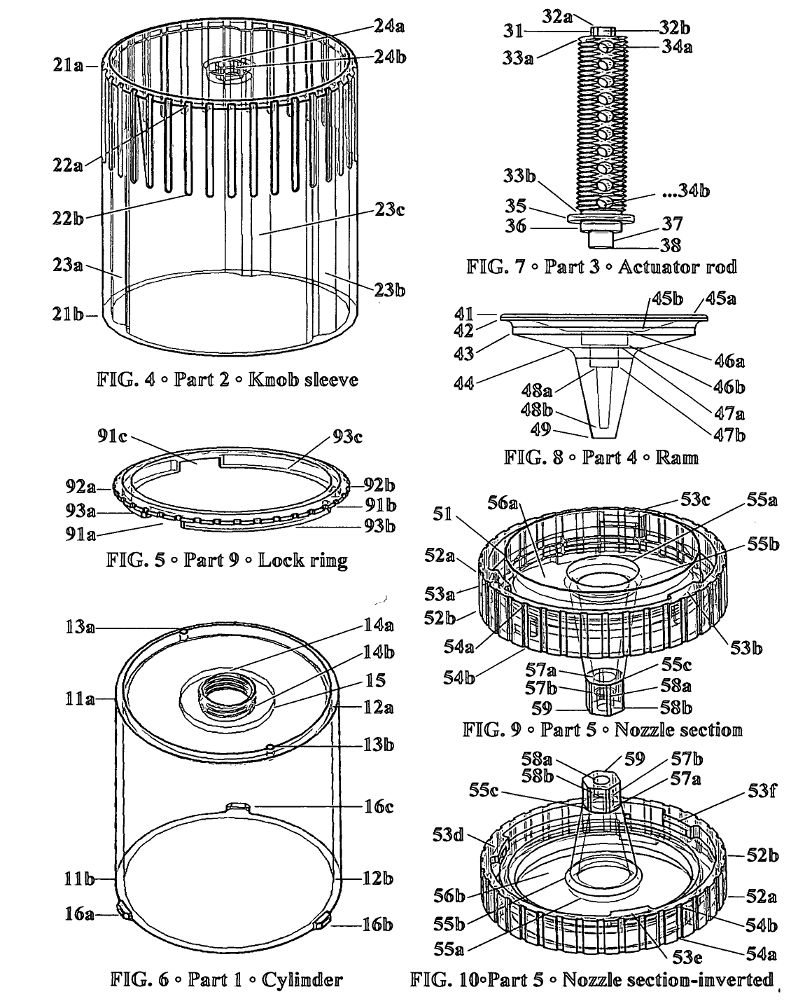

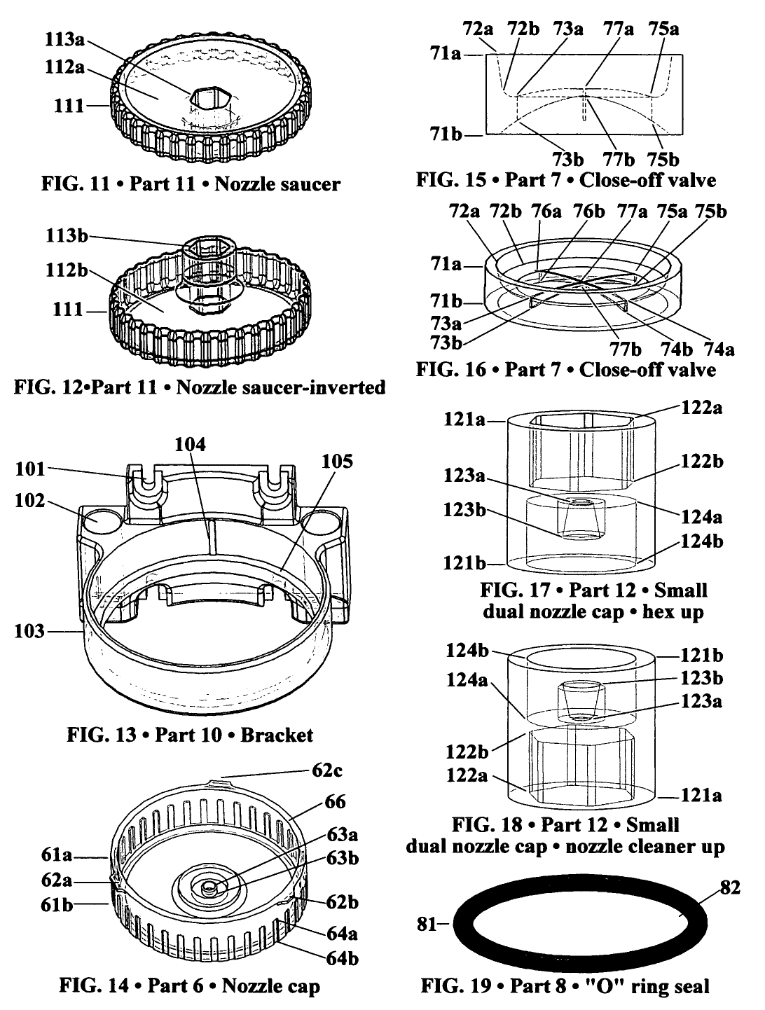

Referring to FIGS. 1-19, dispenser comprises P1 cylinder to hold product. P3 actuator rod 33a-33b is threaded up through bottom inside cylinder hub 14b-14a. Actuator rod flange 35 goes against cylinder hub bottom 15 to prevent actuator rod being threaded out of cylinder hub 14b-14a by consumer.

When P4 ram is in initial product—filled position, ram top wall 41 is against cylinder top inner wall 11a. Cylinder center hub 14b with internal threads comes down inside cylinder to be against actuator rod flange top 35. Bottom of flange 35 is even with P4 Ram dished out center 45b-46a. This provides cylinder hub 14a-14b the maximum rigidity to keep actuator threaded rod in concentricity—as knob rotates actuator rod—to move ram down to dispense product.

P9 lock ring must be inserted over cylinder hub end before P2 knob sleeve is placed over cylinder. Knob sleeve top well flats 24a, 24b slide over actuator top two flats 32a, 32b to lock actuator to knob.

Assembly is set with knob down—open cylinder end up. Ram is inserted in open end of cylinder with ram well 46a-46b over actuator disk 36 and ram well 47a-47b over actuator spindle 37.

P8 “O” ring seal inner wall 82 is forced over ram side wall 43-42. This brings “O” ring seal outer wall 81 into compression against cylinder inner wall almost to top of cylinder. This allows maximum size of “O” ring seal and a greater compression factor than conventional methods—that lock seal in at both top and bottom. “O” ring seal will compress down as much as needed to prevent lock-up. This arrangement allows a more versatile and better seal to compensate for draft and molding variation.

Cylinder is filled with product. P5 nozzle section inner wall 52a-52b is inserted over cylinder outer wall at 11b. Nozzle section projections 53a, 53b, 53c are rotated over cylinder tabs 16a, 16b, 16c to lock nozzle section to cylinder. Cylinder bottom wall circumference at 11b-12b has radius to give slightly when pressured against nozzle section inner wall 56a for more effective sealing.

Nozzle circular sleeve 51 goes inside cylinder wall 12b to provide further seal. Simultaneously, nozzle inner horizontal wall 56a moves up inside cylinder to force product into and possibly even through P7 molded rubber close-off valve—locked into nozzle section at 57a-57b—and through nozzle tip orfice at 58a-58b. This expels virtually all air from nozzle tip before inserting tamper-proof seal (not shown) over nozzle end 59.

Lock ring openings 91a, 91b, 91c are placed over nozzle section projections 53a, 53b, 53c. Lock ring walls 93a, 93b, 93c are pressed into space between nozzle section projections 53a, 53b, 53c. This prevents nozzle section from being rotated out of cylinder and provides neater appearance. Cylinder and nozzle section could be sonic-welded together.

Assembly line could have positioning holes for actuator rods to be placed into—if desired to place sealant—as paraffin through cylinder vent holes 13a or 13b. Sealant would be pressured into one vent hole and would go into space above “O” ring seal and between ram top wall 41. Air would be expelled through opposite vent hole until paraffin comes out opposite vent hole. Knob sleeve would then be placed over actuator top.

Some items may require tamper-proof seal—in which case P12 small dual nozzle cap with hex 122a-122b would firmly fit over nozzle end hex 59 with tamper-proof seal already attached. Other end 121b of small dual nozzle cap has projection 123b-123a to go inside nozzle tip for cleaning of products and push close-off valve back to original position.

Consumer can receive amount of product desired by amount knob is rotated. Actuator rod 33b-33a threads through cylinder hub 14a-14b. Actuator spindle bottom 38 touchs ram bottom well 47b slightly before actuator disk bottom wall 36 makes contact with ram well at 46b-47a. Downward push of actuator is concentrated at the very center of ram to assure the ultimate equalization of downward pressure on ram.

Spindle vertical wall 37—rotating in lower ram well 47a-47b and actuator disk bottom horizontal wall 36 rotating in ram upper well 46b-47a-prevent ram from tilting to assure smooth downward movement.

In event ram did tilt slightly—actuator spindle horizontal bottom wall 38—rotating against ram well bottom 47b and actuator disk horizontal bottom wall 36—rotating against ram horizontal wall 46b-47a—would push ram into alignment- to maintain concentricity of ram—to move ram smoothy toward nozzle end to expel product. Action does not rotate ram but forces ram toward nozzle tip. Actuator rod has holes 34a . . . 34b cored to save plastic and provide rigidity.

On initial assembly, close-off valve outer wall 71a-71b is press-fit into nozzle section tip 57a—and positioned at bottom by nozzle section ledge 57b. Close-off valve has four slits from center 77a-77b to: 73a-73b, 74a-74b, 75a-75b, 76a-76b-which create four flaps.

Spherical roof wall is concaved upward and becomes progressively thicker from center 77a-77b to outer circumference of the four flaps. A small amount of product is retained in nozzle section orfice 58a-58b to keep air away from valve section. Both P6 or P12 nozzle cap can clean nozzle inner tip and push valve back to original position.

Less viscous products as mustard and honey would not require as much pressure to flow through the four flaps and would not open the four flaps as wide—when ejecting product through nozzle tip orfice 58a-58b. The greater pressure to eject highly viscous products as caulking and peanut butter would open the four flaps wider.

The high leverage of the threaded screw rod going through cylinder threaded hub is essential for the close-off valve to operate in the above described manner. Spherical roof wall with four flaps can be of heavier construction—giving the four flaps greater ability to snap back to original position.

When knob is rotated, flaps open under product pressure—and close when knob and pressure is released. The four flaps snapping back to original position—pull excess product at nozzle tip back inside container—to keep nozzle tip clean and prevent products as caulking and glue from sticking.

P6 regular nozzle cap has center projection 63a-63b. P12 small dual nozzle cap has center projection 123b-123a. These two center projections clean nozzle tip and push close-off valve back to original position—in event valve ever stuck—as with caulking or glue.

Ram section 43-44-49 has same configuration as nozzle section 51-55a-55b to 57a. At extreme bottom, ram fills up space in nozzle section to eject virtually all product. Ram hollow center 48a-48b is cored to save plastic.

In order to make knob sleeve grooves 22a-22b the same diameter as nozzle section grooves 54a-54b, knob sleeve has three vertical inner projections 23a, 23b, 23c to serve as bearings against cylinder outside wall circumference 11a-11b. With this arrangement, any knob sleeve groove 22a-22b or nozzle section groove 54a-54b will slide into and down to bracket circular ledge 105—being prevented from rotating by groove locking into center vertical rib 104.

With nozzle section locked into bracket, nozzle section tip would point down. With knob sleeve locked into bracket, nozzle section tip would point up. Nozzle saucer has hex center hole 113a-113b to slide over nozzle section tip hex outer wall 59. Nozzle saucer hex center hole 113a would be level with nozzle section tip hex outer wall 59. Reservoir 112a receives product. Curved notchs 111 on saucer circumference are designed to make cleaning easier for consumer. Nozzle saucer can be slide on and off by consumer. Nozzle saucer or nozzle section can be rotated to pump products as artists' paints, lotions, bean—cheese dips into nozzle saucer. Rotating nozzle saucer with knob stationary—is the same as rotating knob sleeve with nozzle section and cylinder stationary.

Bracket can be attached with double-stick adhesive or screws through slots 101 . . . for convenient use in bathroom, kitchen, shop. Two vertical holes 102 are provided to hold tooth brushes or small industrial items.

It is thus seen—there has been provided a dispenser for viscous and highly viscous liquids and pastes—which is highly effective in keeping product out of contact with air—to maintain integrity of product—after initial opening by consumer. Close-off valve automatically closes on releasing of knob to conveniently maintain a clean nozzle tip. Design of close-off valve automatically compensates for viscosity of liquids and pastes. With ram filling up nozzle section at extreme close-out, virtually all product is ejected from dispenser.

Nozzle cap—in coordination with close-out valve and nozzle orfice keeps products as caulking and glues from sticking in bottom of nozzle orfice. Dispenser is economical to manufacture, assemble and fill and is extremely versatile and convenient for usage in a tremendous number of products.

Knob sleeve can be locked in bracket or other accessory with nozzle section and cylinder in horizontal position. Products that have oil rising to top—as natural peanut butter would have oil automatically integrated into mixture as nozzle section and cylinder rotate on each dispensing action.

While only preferred embodiments of this invention have been described, it is understood that many variations are possible without departing from the principles of this invention as defined in the claims which follow.

1. A dispenser for viscous and highly viscous liquids and pastes comprising:
(a) having P1 cylinder for containing product with threaded hub on one end and two vent holes on same end.
(b) having P2 knob sleeve attached to top of threaded actuator rod—so rotation of knob rotates actuator rod—with knob sleeve rotating around cylinder outer circumference.
(c) having P3 actuator rod thread through cylinder hub with actuator disk and spindle rotating in ram wells.
(d) having P4 ram with provision for placing “O” ring seal on circumference of ram; with provision for ram wells to receive actuator rod disk and actuator rod spindle; with provision for ram to force product to nozzle end.
(e) having P5 nozzle section with provision for locking into and sealing cylinder from inside, outside and bottom; with provision to expel air from container on initial filling by manufacturer; and to coordinate with ram bottom to expel virtually all product from dispenser.
(f) having P6 nozzle cap with means for locking into nozzle section and sealing nozzle tip; means to clean inside nozzle tip; and to bring close-off valve back to original position.
(g) having P7 close-off valve with provision to press-fit into nozzle section; to automatically compensate for viscosity of products to open and close properly; to pull excess product at nozzle tip back into nozzle on release of knob.
(h) having P8 “O” ring seal to fit over ram circumference with bottom open—to provide maximum sealing ability.
(i) having P9 lock ring with provision for filling empty space between cylinder and nozzle section for better appearance and to prevent backward rotation of nozzle section off cylinder.
(j) having P10 bracket with provision to lock nozzle section or knob sleeve inside bracket.
(k) having P11 nozzle saucer with provision for attaching to nozzle tip to have product pumped into saucer reservoir.
(l) having P12 dual nozzle cap for sealing nozzle tip and means for other end to clean inside nozzle tip, and to bring close-off valve back to original position.

2. The dispenser of claim 1 in which said cylinder has means to thread actuator rod through hub to provide leverage to precisely control amount dispensed of highly viscous products as caulking and peanut butter.

3. The dispenser of claim 1 in which said cylinder has two vent holes 13a and 13b—that on initial filling of product by manufacturer—sealant as paraffin can be pumped into one hole to fill up circumference above “O” ring seal and between ram top outer wall 4142- to allow air to exit from opposite hole—to provide increased sealing of product for longer shelf life—with provision for vent holes to open on initial dispensing of product by consumer.

4. The dispenser of claim 1 in which said actuator rod—attached to knob sleeve—is threaded through cylinder hub;
in coordination with ram wells and cylinder—has leverage to precisely control amount dispensed of highly viscous products as caulking and peanut butter.

5. The dispenser of claim 4 in which said actuator rod disk 36 rotating in ram well 46a-46b prevents ram from tilting;
and said actuator rod spindle 37 rotating in ram well 47a-47b prevents ram from tilting;
and in event ram did tilt slightly, actuator disk horizontal bottom wall 36 rotating in ram horizontal well bottom wall 46b-46a would push ram back into alignment;
in which said actuator rod spindle bottom 38 touchs ram well bottom 47b slightly before actuator disk bottom 36 touchs ram well bottom 46b-47a—to concentrate force at ram well center 47b-to assure equalization of downward pressure on ram—to maintain concentricity of ram—to move ram smoothly to nozzle end to expel product.

6. The dispenser of claim 1 in which said ram has ram 46a-46b for actuator disk 36 to rotate in;
in which said ram has ram well 47a-47b for actuator spindle 37 to rotate in;
in which said ram wells coordinate with actuator rod disk and actuator rod spindle to prevent ram from tilting;
and in event ram did tilt, ram wells coordinating with actuator rod disk and actuator rod spindle—would push ram back into alignment;
to maintain concentricity of ram—to move ram smoothly toward nozzle end to expel product—alternate claim 5.

7. The dispenser of claim 1 in which said nozzle section has provision to lock into cylinder from inside, outside and bottom;
whereby nozzle section inner wall 52a-52b is inserted over cylinder outer wall at 11b; nozzle section projections 53a, 53b, 53c are rotated over cylinder tabs 16a, 16b, 16c to lock nozzle section to cylinder;
cylinder bottom wall circumference 11a-11b has small radius to enable cylinder to give slightly when pressured against nozzle section inner bottom wall 56a to provide more effective sealing;
said nozzle circular sleeve 51 slides inside cylinder bottom wall 12b;
while simultaneously, nozzle section lower horizontal wall 56a moves inside cylinder to cause product to be forced through close-out valve at nozzle tip position 57a-57b and possibly out nozzle tip 58a-58b—to remove virtually all air from dispenser—on initial product filling.

8. The dispenser of claim 1 in which said lock ring has provision for lock ring openings 91a, 91b, 91c to be placed over nozzle section projections 53a, 53b, 53c;
with provision for lock ring walls 93a, 93b, 93c to be pressed into space between nozzle section projections 53a, 53b, 53c to prevent backward rotation of nozzle section in cylinder;
to fill space between nozzle section projections and cylinder tabs for a neater appearance.

9. The dispenser of claim 1 in which said nozzle saucer has means for products as artists' paints, body lotions, pastes as bean—cheese dips to be pumped into saucer; with provision for nozzle saucer hex center hole 113b-113a to slide over nozzle section tip hex outer wall 59 with nozzle saucer hex center hole 113a level with nozzle section tip hex outer wall 59;
so that rotation of knob pumps product into nozzle saucer reservoir 112a;
having curved notches 111 on saucer circumference to make cleaning easier for consumer.

10. The dispenser of claim (1) in which said close-off valve has provision for close-off valve outer wall 71a-71b to be press-fit into nozzle section tip inner wall at 57a-57b;
having four slits from valve center 77a-77b to outer circumference 73a-73b, 74a-74b, 75a-75b, 76a-76b; to create four flaps;
whereby four flaps have thinner center wall and become progressively thicker toward outer circumference—to coordinate with spherical roof—so that flaps open and close properly—to automatically compensate for viscosity of product;
whereby close-off valve walls can be of heavier construction—giving maximum ability for the four flaps to snap back to original position—with vacuum force pulling excess product at nozzle tip back into nozzle to keep nozzle tip clean;
operation of close-off valve and coordinating parts—being successful because of the great leverage provided by the dispenser of this invention; cylinder hub and actuator rod having 10 to 16 threads per inch.
